(19) United States
(12) Patent Application Publication
(10) Pub. No.: US 2013/0308413 A1
(43) Pub. Date: Nov. 21, 2013

(54) MEANS AND METHOD FOR STIRRING LIQUIDS IN LONG THIN CONTAINERS

(71) Applicants: Masaru Kishimoto, Tokyo (JP); Takafumi Fuse, Saitama (JP); Akira Harada, Tokyo (JP); Toshiyuki Kasamatsu, Tokyo (JP)

(72) Inventors: Masaru Kishimoto, Tokyo (JP); Takafumi Fuse, Saitama (JP); Akira Harada, Tokyo (JP); Toshiyuki Kasamatsu, Tokyo (JP)

(73) Assignee: NICHIREI BIOSCIENCES INC., Tokyo (JP)

(21) Appl. No.: 13/981,604

(22) PCT Filed: Jan. 27, 2012
(86) PCT No.: PCT/JP2012/051756

§ 371 Date: Jul. 25, 2013

(30) Foreign Application Priority Data
Jan. 28, 2011 (JP) 2011-016860

(51) Int. Cl. B01F 15/06; B01F 13/08

(52) U.S. Cl. CPC B01F 15/06; B01F 13/08
USPC 366/144

(57) ABSTRACT

Provided is a thermostat with reduced temperature difference within the tank when a solution is being heat-treated. Stirring guides (114) for guiding a water-flow generated by a stirring bar (113) to both ends of a tank (106) in the longitudinal direction are disposed on the bottom of the tank (106). Thus, the water-flow generated by the stirring bar (113) is efficiently guided to both ends of the tank (106) in the longitudinal direction while keeping its momentum, and therefore a circulating water-flow for homogenizing the temperature of the water within the tank (106) can be effectively generated.

### TECHNICAL FIELD

The present invention relates to a technique suitable to be applied to a thermostat.

More particularly, the present invention relates to a thermostat in which a tank having a shape so that slide glasses can be efficiently housed therein, and which can eliminate unevenness of the temperature of the solution within the tank.

### BACKGROUND ART

In medical front, a health professional or the like performs an enzyme antibody response (referred to as “immunohistochemical staining”) by using a body tissue obtained from a subject and a regent, such as an antibody, to thereby perform pathological diagnosis.

Typically, the body tissue (which is the object to be tested) is fixed with a fixative, such as a buffered formalin solution or the like, so as to keep the antigenicity and morphology thereof. Thereafter, the fixed tissue is embedded in paraffin, so that the tissue can be thinly sliced, and the tissue slice is affixed to a well-known slide glass. In such a manner, the body tissue having been subjected to both the formalin fixation and the paraffin embedding is in a state in which the antigenicity thereof is hidden (masked) due to the cross-linking reaction caused by aldehyde fixation of formalin, and therefore the antibody is unlikely to contact the antigen.

In current pathological examination, as a pretreatment prior to the immunohistochemical staining, a treatment called “antigen retrieval” is performed by a method suitable for a specific substance (antigen) (see Non-patent document 1).

The necessity, type and condition of the antigen retrieval differ depending on the fixation condition of the tissue and the clone of the antibody; wherein representative methods of the antigen retrieval are protein enzyme decomposition treatment and heat treatment. The protein enzyme decomposition treatment is performed using trypsin, pepsin, protease or the like. The heat treatment is performed using a commercially available microwave, autoclave, water bath, pressure cooker, steam cooker, or the like.

[Patent document 1] Japanese Unexamined Utility Model (Registration) Application Publication No. S59-127729

[Non-patent document 1] The 4th revised edition, Watanabe Nakane Enzyme Antibody Technique, edited by Nagura Hiroshi, Osamura Yoshiyuki, Tsutsumi Hiroshi, published in 2002 Gakusaikikaku

[Non-patent document 2] “PTLink” Dako Japan Co. Ltd., in the Internet <URL: http://www.dako.jp/index/support/home system/ptlink.htm>[searched on Jan. 16, 2011]

[Non-patent document 3] “LAB VISION PT MODULE” Thermo Fisher Scientific, in the Internet <URL: http://www.labvision.com/pdf/uvdatasheet/PT-Module.pdf>[searched on Jan. 16, 2011]

### DISCLOSURE OF THE INVENTION

### Problems to be Solved by the Invention

Generally, in the site of pathological examination, general-purpose utensils, instead of exclusive devices, are diverted to the devices for performing the aforesaid heat treatment. Examples of the general-purpose utensils include cooking utensils such as a well-known microwave, pressure cooker and the like. In order to divert these general-purpose utensils to the pathological examination, a container having a buffer solution (citrate buffer solution [ph 6.0], Tris-EDTA [ph 9.0] or the like) sealed therein is commercially available, wherein the buffer solution is used for activating antigenicity.

However, since the use of such utensils, which are not officially applied to the pathological examination, goes beyond the original expected purposes, not only accuracy of the result of the pathological examination obtained using such utensils can not be guaranteed, but also the service life of the utensils and the safety of the site of the pathological examination can not be guaranteed. Also, since the utensil is used beyond its expected purposes, it is considered that there will be many elements that lead to inefficiency in inspections such as immunohistochemical staining test and the like.

In order to respond to the request from the site of the pathological examination, several types of equipment for performing the pathological examination have been developed recently. As examples of such equipment, heat treatment machines exclusively for the pathological examination are disclosed in Non-patent document 2 and Non-patent document 3. In such heat treatment machines, a buffer solution is poured into a rectangular stainless-steel tank for efficiently housing slide glasses in a limited space, and the bottom of the tank is directly heated by a band heater. Since the machine can be programmed to raise and lower the temperature, when performing heat treatment, involvement of the user can be reduced as much as possible compared with the conventional general purpose heating machines. However, since such machines have no function for homogenizing the temperature, temperature difference is likely to be generated between the upper portion and the lower portion of the tank.

It is considered to use a well-known magnetic stirrer to eliminate the temperature difference generated within the tank (see Patent document 1, for example). However, the magnetic stirrer of the conventional technology is designed based on a consideration that the magnetic stirrer is used in a beaker or the like, and therefore it is not suitable to be used to stir a long thin tank. Actually, the inventor of the present invention has performed an experiment to apply the magnetic stirrer to the long thin tank, and found that the temperature difference could not be eliminated. Incidentally, to stir the long thin tank with the magnetic stirrer of the conventional technology, a plurality of the magnetic stirrers will be needed to place.

The present invention is conceived to solve the above problems, and it is an object of the present invention to provide a stirring device with reduced temperature difference within the tank when a solution is being heat-treated.

### Means for Solving the Problems

To solve the above problems, a thermostat according to an aspect of the present invention includes a tank formed in a shape that having a longitudinal direction and a transversal direction and adapted to contain a liquid; a temperature changing unit arranged on the outer side of the tank and adapted to change the temperature of the liquid through the tank; a rotating body arranged within the bottom of the tank; a drive unit adapted to rotary-drive the rotating body; and a bottom-side water conduit arranged with the bottom of the tank in a position adjacent to the rotating body and adapted to guide a water-flow generated in the liquid by rotating the rotating body to an end of the tank in the longitudinal direction and then open the water-flow upward.

According to the present invention, in the thermostat, the water conduit for guiding the water-flow generated from the stirring bar to the end of the tank in the longitudinal direction is arranged on the bottom of the tank. Thus, the water-flow generated from the stirring bar is efficiently guided to the end of the tank in the longitudinal direction while keeping its momentum, and therefore the circulating water-flow for homogenizing the temperature of the water within the tank can be effectively generated.

### Advantages of the Invention

The present invention is conceived to provide a thermostat with reduced temperature difference within the tank when a solution is being heat-treated.

### BRIEF DESCRIPTION OF DRAWINGS

FIG. 1 is a perspective view showing the external appearance of a thermostat according to an embodiment of the present invention when viewed diagonally from the front upper side of the device;

FIG. 2 is a view showing the external appearance of the thermostat according to the aforesaid embodiment when viewed from the back of the device;

FIG. 3 is a perspective view showing the external appearance of a tank and an inner lid used in the thermostat according to the aforesaid embodiment;

FIG. 4 is a perspective view showing the external appearance of a stirring bar used in the thermostat according to the aforesaid embodiment;

FIG. 5 is a perspective view showing the external appearance of a stirring guide used in the thermostat according to the aforesaid embodiment;

FIG. 6 is a cross-sectional view showing a cross section of a portion of the thermostat according to the aforesaid embodiment;

FIG. 7 is a perspective view showing the external appearance of a slide basket used in the thermostat according to the aforesaid embodiment;

FIG. 8 is a schematic view for explaining the operation of the thermostat according to the aforesaid embodiment;

FIG. 9 is a partly enlarged perspective view of the stirring guide used in the thermostat according to the aforesaid embodiment;

FIG. 10 is a photo of a slide glass before performing treatment in an experiment to remove an embedding agent attached to the slide glass, in a case where a room-temperature liquid is used in the thermostat according to the aforesaid embodiment;

FIG. 11 is a photo showing results of the experiment to remove the embedding agent attached to the slide glass, in the case where a room-temperature liquid is used in the thermostat according to the aforesaid embodiment;

FIG. 12 is a perspective view showing the external appearance of a spacer, the stirring guide, and the tank;

FIG. 13 is a perspective view showing the external appearance of the spacer and the stirring guide;

FIG. 14 is a perspective view showing the external appearance of the spacer and the stirring guide in a state where the spacer is mounted on the stirring guide;

FIG. 15 is a transverse cross section of the tank in a state where the spacer has been housed; and

FIG. 16 is a view showing the concept of the water conduit formed by the spacer, the tank and the stirring guide.

### BEST MODES FOR CARRYING OUT THE INVENTION

[Entire Configuration]

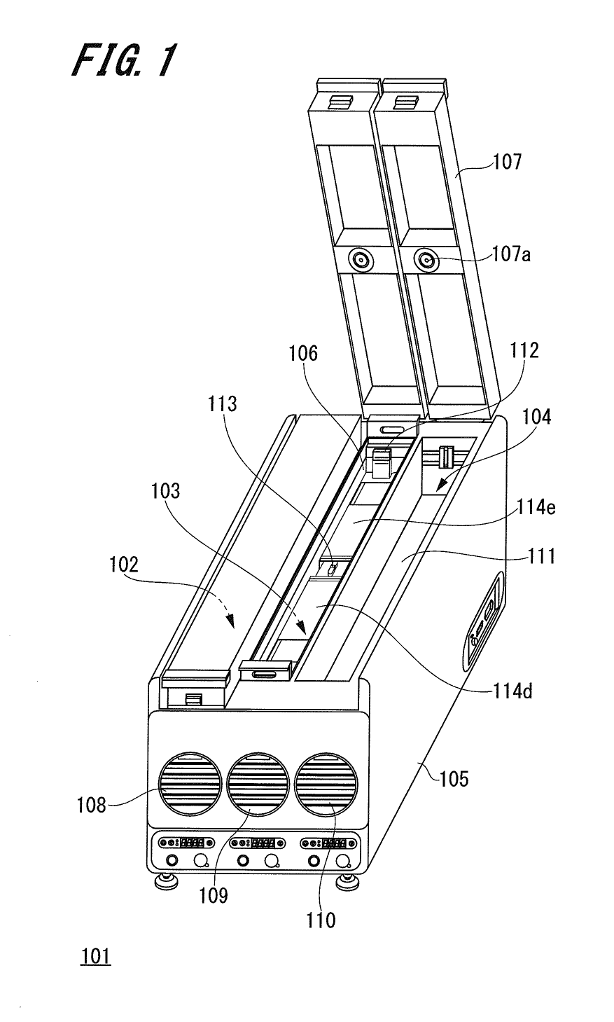

FIG. 1 is a perspective view showing the external appearance of a thermostat according to an embodiment of the present invention when viewed diagonally from the front upper side of the device.

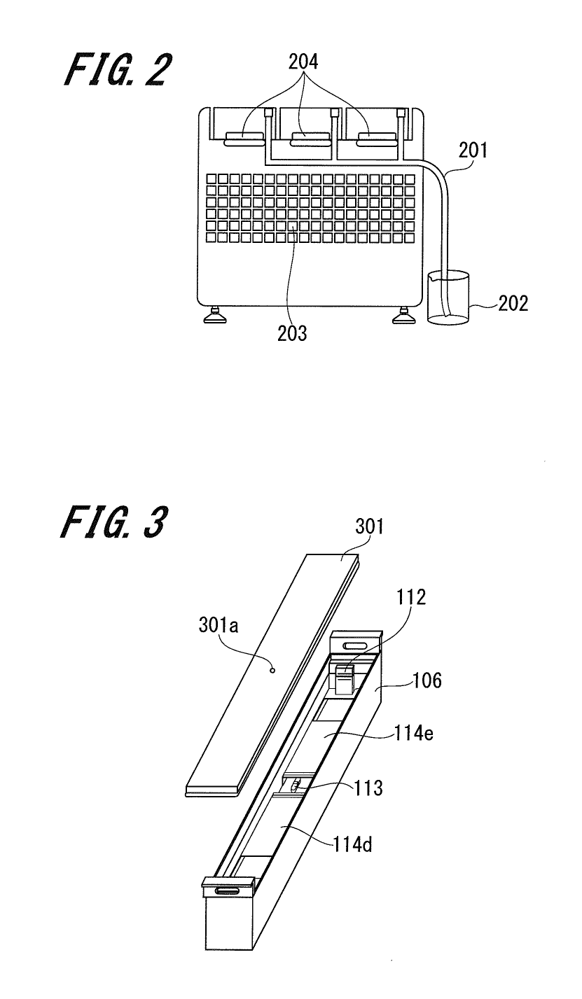

FIG. 2 is a view showing the external appearance of the thermostat according to the aforesaid embodiment when viewed from the back of the device.

FIG. 3 is a perspective view showing the external appearance of a tank and an inner lid shown in FIG. 1.

Since the thermostat according to the aforesaid embodiment has a function of stirring liquid, it is also referred to as a “stirring device”.

A thermostat 101 has a casing 105 in which a first tank housing 102, a second tank housing 103 and a third tank housing 104 are provided. Three outer lids 107 for opening/closing the first tank housing 102, the second tank housing 103 and the third tank housing 104 respectively are each connected to the casing 105 through a hinge 204.

The first tank housing 102, the second tank housing 103 and the third tank housing 104 each house a tank 106 of the same shape. The tank 106 has a liquid, such as water, a solution or the like, housed therein. It is preferred that the tank 106 is formed of a material stable to heat and various chemical substances such as sodium chloride. Also, it is preferred that the tank is formed of a non-magnetic stainless steel, for example.

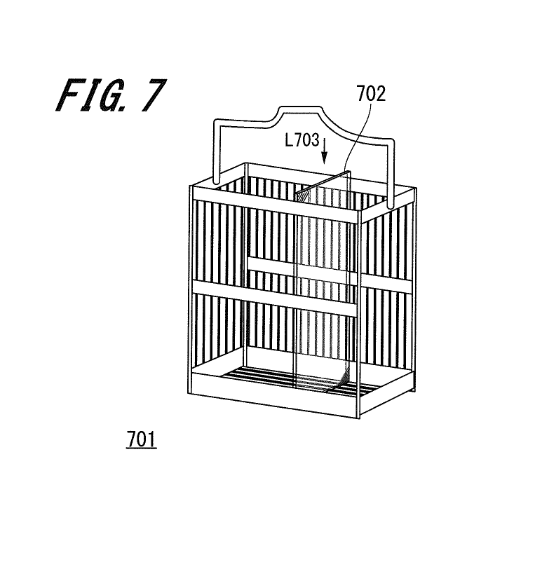

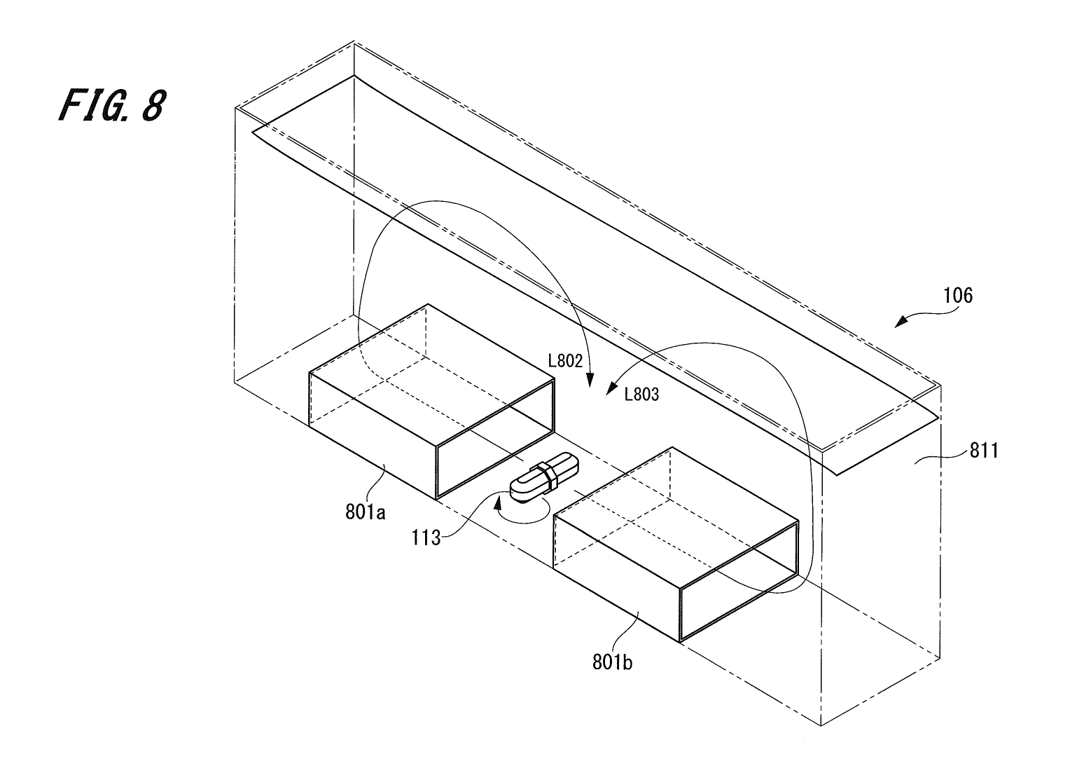

Further, the tank 106 has a rectangular parallelepiped-shape suitable for housing many slide glasses 702, which are to be described later (see FIGS. 7 and 8). A packing (which is to be described later) is arranged around the opening in the upper side of the tank 106 to achieve a hermetically-closed state along with a tank cover 301.

The first tank housing 102, the second tank housing 103 and the third tank housing 104 are thermally separated from each other by a dividing wall (not shown), so that the three tanks can be heated or cooled at the same time by setting different temperatures and/or times from each other under the control of a microcomputer (not shown). Further, since the thermostat 101 has three independent tank housings, it is possible to efficiently perform operation of various pathological examinations in a short time.

A tank cover 301 (also referred to as an “inner lid”) is interposed between the outer lid 107 and the tank 106 (see FIG. 3). The tank cover 301 separates the inside of the tank 106 from the outside, and ventilation can only be done through a steam hole 301a provided at the center of the tank cover 301.

A steam hole 107a is formed in the outer lid 107 at a position facing the steam hole 301a of the tank cover 301.

The steam hole 107a of the outer lids 107 is connected to a steam pipe 201, so that the steam generated from the tank 106 is finally discharged from the steam pipe 201. Further, the tip end of the steam pipe 201 is put into an arbitrary container, such as a beaker 202 or the like, so that water drops discharged from the steam pipe 201 do not leak.

The front face of the casing 105 is provided with a first inlet 108, a second inlet 109 and a third inlet 110. The first inlet 108 corresponds to the first tank housing 102, the second inlet 109 corresponds to the second tank housing 103, and the third inlet 110 corresponds to the third tank housing 104. The first inlet 108, the second inlet 109 and the third inlet 110 are each provided with a fan (not shown) in the inner side thereof, wherein the fans are adapted to fan the respective tanks 106 located at the corresponding positions. The air sucked by the first inlet 108, the second inlet 109 and the third inlet 110 touches respective tanks 106, and then is discharged from an outlet 203 provided on the back side of the casing 105. The fans (not shown) provided in the first inlet 108, the second inlet 109 and the third inlet 110 are mainly used to cool, with airflow, the tanks 106 whose temperature has been raised.

The first tank housing 102, the second tank housing 103 and the third tank housing 104 are each provided with a band heater 111 on the underside thereof for heating the respective tanks 106, wherein the band heater 111 has substantially the same shape as the bottom of the tank 106.

A water level sensor 112 is provided at one end within the tank 106. A float (not shown) having a magnet enclosed therein is housed in the water level sensor 112. The first tank housing 102, the second tank housing 103 and the third tank housing 104 are each provided with a reed switch (not shown) arranged at a position corresponding to the water level sensor 112.

In a state where the tank 106 is not filled with water or solution, the float will be situated on the lower side due to gravity. At this time, the magnet enclosed in the float comes close to the reed switch to turn on the reed switch.

While in a state where the tank 106 is filled with water or solution, the float will be situated on the upper side due to buoyancy. At this time, since the magnet enclosed in the float is located at a position separated from the reed switch, the reed switch is in “off” state.

Thus, when the tank 106 is not filled with sufficient water or solution, the reed switch is in “on” state. In other words, if the tank 106 is heated by the band heater 111 in the state where the tank 106 is not filled with sufficient water or solution, there will be a risk that the tank 106 might be heated in an empty state, and therefore a microcomputer (not shown) built in the thermostat 101 detects the “on” state of the reed switch to prohibit heating operation and cause a predetermined alarm operation.

Further, although not shown in the drawings, the thermostat 101 is also provided with micro switches for detecting presence of the tanks 106 and micro switches for detecting opening/closing of the outer lids 107. These micro switches are adapted to detect whether or not the tanks 106 have been housed in the tank housings and whether or not the outer lids 107 have been closed. In other words, the microcomputer (not shown) permits to perform heating operation when the tanks 106 are housed in the tank housings, the tanks 106 are filled with a predetermined amount of water or solution, and the outer lids 107 are closed.

Further, a stirring bar 113 is arranged at the center of the bottom within the tank 106. Stirring guides 114d and 114e are provided on both sides of the stirring bar 113. Since the stirring guide 114d and the stirring guide 114e have the same shape, hereinafter both the stirring guide 114d and the stirring guide 114e are collectively referred to as a “stirring guide 114”. The stirring bar 113 and the stirring guide 114 are important elements of the present invention.

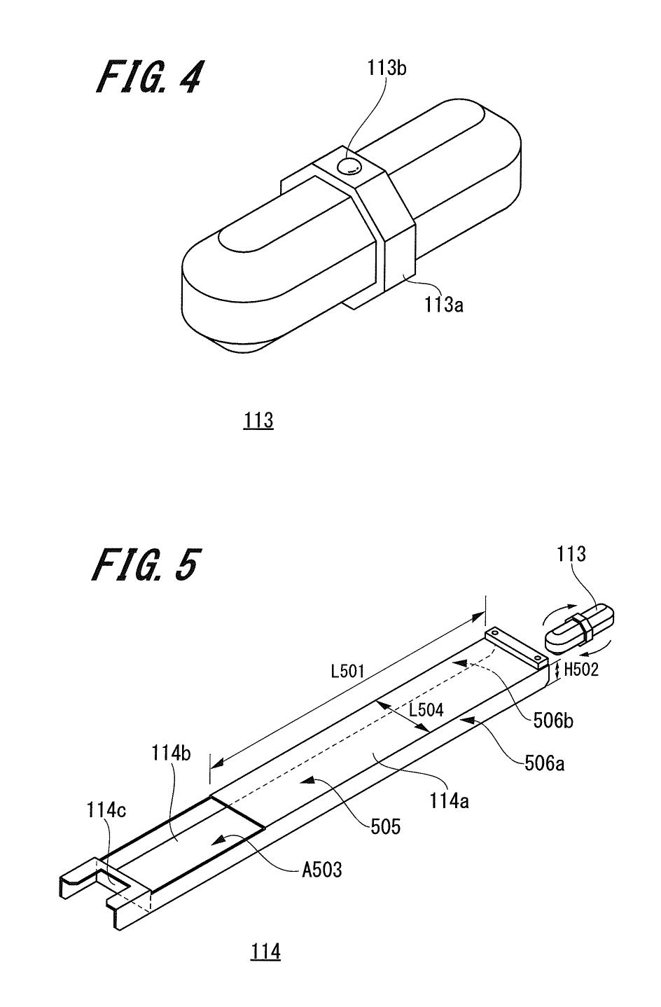

FIG. 4 is a perspective view showing the external appearance of the stirring bar 113.

The stirring bar 113 is a stirring bar used in a well-known automatic stirring device used to perform a chemical experiment or the like. The stirring bar 113 is configured by enclosing a small bar magnet formed of ferrite or the like into a synthetic resin such as fluororesin. As shown in FIG. 4, the stirring bar 113 is a bar-like rotating body having an octagon-shaped section, and both tip ends of the stirring bar 113 are each rounded into a semicircular shape. A projection 113b is formed in a ring portion 113a provided at the center of the stirring bar 113, the projection 113b being the rotating center.

FIG. 5 is a perspective view showing the external appearance of the stirring guide 114.

Similar to the tank 106, the stirring guide 114 is formed by sheeting a stainless steel material.

The stirring guide 114 is a rectangular member, and includes a water conduit cover 114a, an opening 114b and a shielding plate 114c, in order of the distance from the stirring bar 113.

The water conduit cover 114a has a U-shaped longitudinal section, and includes a rectangular upper plate 505 and two side plates 506a and 506b, wherein the two side plates 506a and 506b are respectively formed continuously from the two long sides of the upper plate 505.

The opening 114b is formed by cutting a part of the upper plate 505 of the water conduit cover 114a. A flat surface of the shielding plate 114c faces the stirring bar 113.

The water-flow generated in the liquid due to the rotation of the stirring bar 113 is guided by the water conduit cover 114a to the ends of the tank 106 in the longitudinal direction, and expelled upward from the opening 114b. At this time, the water-flow does not flow forward from the shielding plate 114c.

The water level sensor 112 (see FIG. 1) is arranged above a position where the shielding plate 114c is located. Due to the provision of the shielding plate 114c, the water-flow passed through the water conduit cover 114a does not hit the water level sensor 112.

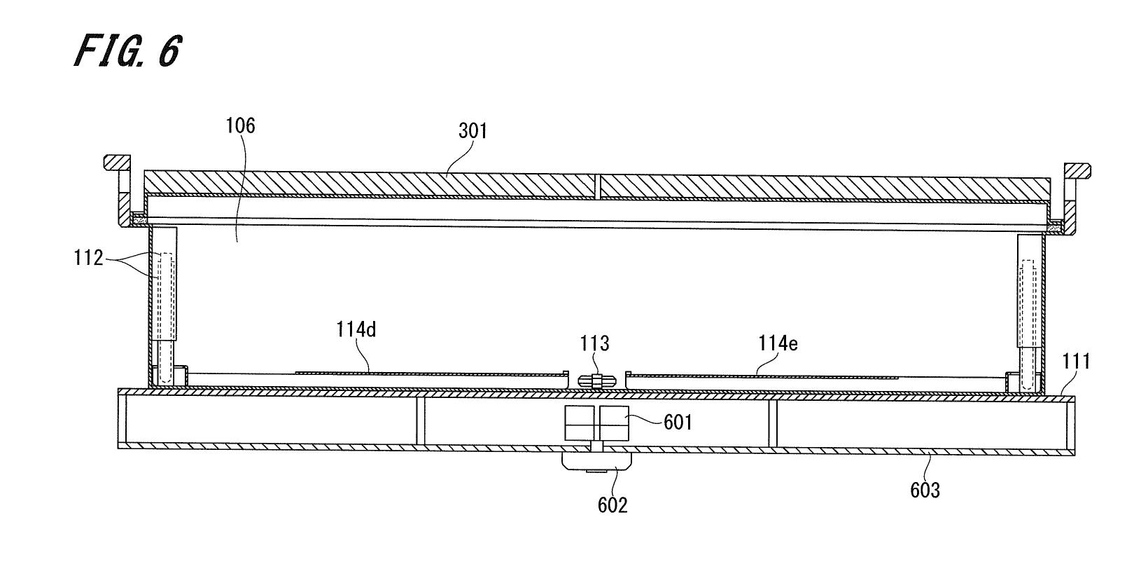

FIG. 6 is a partial cross-section of the thermostat 101.

The band heater 111 is arranged right below the tank 106. A magnet 601 and a motor 602 that rotary-drives the magnet 601 are fixed by a frame 603 to a position just beneath the central portion of the band heater 111. The combination of the magnet 601 and the motor 602 is a concrete example of a drive unit according to the present invention.

When the motor 602 rotates, the magnet 601 is rotary-driven. Since the magnetic force of the magnet 601 acts on the stirring bar 113 within the tank 106 through the band heater 111, when the magnet 601 is rotary-driven, the stirring bar 113 will be rotary-driven. Thus, the magnet 601 is also referred to as a “driving magnet” that drives the stirring bar 113.

The frame 603 also plays a role in creating a distance between the magnet 601 and the band heater 111, so that the magnet 601 and the motor 602 are not affected by the radiant heat of the band heater 111.

FIG. 7 is a perspective view showing the external appearance of a slide basket.

A slide basket 701 can house a plurality of slide glasses 702 in a manner that the plurality of slide glasses 702 are arranged in a direction parallel to the short side of the bottom of the slide basket 701. The plurality of slide glasses 702 are housed within the slide basket 701 in the direction of arrow L703. The length of the short side of the bottom of the slide basket 701 is substantially equal to the width of the stirring guide 114, and the slide basket 701 is housed in the tank 106 in a manner that the short side of the bottom thereof is substantially parallel to the transversal direction of the tank 106. In the thermostat 101 of the present embodiment, the number of the slide basket 701 possible to be housed in the tank 106 is up to five.

FIG. 8 is a schematic view for explaining the operation of the thermostat 101.

The stirring guide 114 is equivalent to two pipe-like rectangular parallelepiped-shaped water conduits 801a and 801b formed on both sides of the stirring bar 113.

When the stirring bar 113 rotates within the tank 106 filled with water 811, a water-flow will be generated around the stirring bar 113. The water-flow generated around the stirring bar 113 is guided to the water conduit 801a and the water conduit 801b formed near the stirring bar 113, and expelled from the outlet of the water conduit 801a and the outlet of the water conduit 801b. Further, the water-flow expelled from the outlet of the water conduit 801a and the water-flow expelled from the outlet of the water conduit 801b convect along the direction of arrow L802 and the direction of arrow L803.

As can be known from FIG. 8, by disposing the stirring guide 114 on the bottom of the tank 106, the water-flow generated due to the rotation of the stirring bar 113 is efficiently guided to the ends of the tank 106 in the longitudinal direction. Thus, a circulating water-flow for homogenizing the temperature of the water within the tank 106 can be generated efficiently.

Next, dimensional conditions of the stirring guide 114 will be described below with reference to the FIG. 5 again.

The stirring guide 114 is provided to cause the water-flow generated by the rotation of the stirring bar 113 to reach the ends of the tank 106, so as to generate a convective flow indicated by arrows L802 and L803 shown in FIG. 8. Thus, in order to efficiently generate the convective flow, it is necessary to suitably design a cover length L501 (which is the length of the water conduit cover 114a), a guide height H502 (which is the height of the side facing the stirring bar 113), and the dimensions of an opening area A503 (which is the area of the opening 114b).

First, in order for the water-flow generated by the stirring bar 113 to flow with as little leak as possible, the guide height H502 is preferably equal to or greater than the height of the stirring bar 113. However, it has been known that, if the guide height H502 is greater than the height of the stirring bar 113, when the stirring bar 113 is out of synchronization with the motor 602, an accident that the stirring bar 113 enters the stirring guide 114 will occur. Thus, in an actual stirring guide 114, the guide height H502 is smaller than the height of the stirring bar 113.

Next, in order for the water-flow generated by the stirring bar 113 to be expelled with as little resistance as possible, the opening area A503 is preferably equal to or larger than the area obtained by multiplying the guide height H502 by a guide width L504 (which is the width of the stirring guide 114). In other words, it is preferred that the following relation is satisfied:

Opening area A503≧Guide height H502×Guide width L504

Finally, it is considered that the cover length L501 is dependent both on the water quantity per unit time in the water-flow generated by the stirring bar 113 and on the length of the tank 106 in the longitudinal direction.

The friction between the water-flow generated by the stirring bar 113 and the liquid existing above the water conduit cover 114a is blocked, and the friction between the water-flow generated by the stirring bar 113 and the liquid existing above the opening 114b is caused. In other words, the momentum of the water-flow is weakened by the opening 114b.

Thus, the more the water quantity per unit time is (i.e., the stronger the momentum of the water-flow is), the more possible for the water-flow to reach the ends of the tank 106 even if the cover length L501 is short.

Conversely, the less the water quantity per unit time is (i.e., the weaker the momentum of the water-flow is), the more necessary it is to sufficiently increase the cover length L501 so as to cause the water-flow to reliably reach the ends of the tank 106.

In other words, if the momentum of the water-flow is strong, it is possible to achieve the function as the water conduit cover 114a even if the cover length L501 is short; on the other hand, it is preferred to pay due consideration to convection efficiency of the liquid. Thus, it is preferred that the following relation between the cover length L501 and the length of the tank 106 in the longitudinal direction (referred to as “TL”) is satisfied:

Cover length L501≧TL/4

The thermostat 101 according to the present embodiment was used to perform an experiment to confirm the effects of the stirring guide 114. In the experiment, a test of raising the temperature of the water to 95° C. was performed, wherein the dimensions of respective components were: the cover length L501 was 14 cm, the guide height H502 was 8 mm, the opening area A503 was 16.6 cm², the guide width L504 was 2.9 cm, and the length TL of the tank 106 in the longitudinal direction was 47.5 cm.

In a state where the stirring bar 113 was not rotary-driven, the temperature difference between the end portion and the central portion of the tank 106 was 3.2° C.

In a state where the stirring bar 113 was rotary-driven without provision of the stirring guide 114, the temperature difference between the end portion and the central portion of the tank 106 was 3.3° C.

In a state where the stirring bar 113 was rotary-driven with provision of the stirring guide 114, the temperature difference between the end portion and the central portion of the tank 106 was 1.1° C.

It can be known based on the above results that, owing to the stirring guide 114, the temperature of the liquid within the tank 106 is efficiently homogenized.

The embodiment of the present invention includes the following applications.

(1) The shape of the tank 106 is not limited to rectangular parallelepiped-shape. The tank 106 may be a container of any shape as long as it has a longitudinal direction and a transversal direction. For example, the tank can be formed in an elliptical shape. In other words, the tank may be a container of any shape as long as many slide glasses can be housed therein in the longitudinal direction.

(2) The stirring guide 114 may also be formed in a tube-like shape. In short, the requirement is that the water conduits 801a and 801b shown in FIG. 8 can be formed on the bottom of the tank 106.

(3) The stirring bar 113 may be replace by a turbine.

(4) A Peltier element or a heat pump type cooling mechanism may either be provided instead of the band heater 111 or be provided next to the band heater 111 to cool the liquid within the tank 106. The band heater 111 and/or the Peltier element or a heat pump type cooling mechanism can be collectively referred to as a “temperature changing unit” adapted to change the temperature of the liquid within the tank 106.

(5) The rotating body is not limited to the stirring bar 113. Further, the drive unit is not limited to the magnet 601 and the motor 602 for rotary-driving the magnet 601. For example, the thermostat of the present invention may have a configuration in which, for example, the rotating shaft of a motor is penetrated through the bottom of the tank, and a rotating body such as a turbine or the like is fixed to the tip end portion of the rotating shaft arranged within the tank. In such a case, the motor and the tank need to be liquid-tightly sealed between each other.

(6) Although the slide basket 701 houses the slide glasses 702 in a manner in which the slide glasses 702 are arranged in a direction parallel to short side (the transversal direction) of the tank 106, the shape of the slide basket 701 does not have to be limited thereto, but the slide basket 701 may house the slide glasses 702 in a manner in which the slide glasses 702 are arranged in a direction parallel to the longitudinal direction of the tank 106. If the slide basket 701 houses the slide glasses 702 in a manner in which the slide glasses 702 are arranged in a direction parallel to the longitudinal direction of the tank 106, the number of the slide glasses possible to be housed will be less than the slide basket 701 shown in FIG. 7; however, since the slide glasses 702 are arranged in a direction along the flow of the solution, the flow of the solution is not blocked, and therefore more rapid reaction can be expected.

(7) If an intrusion preventing member for preventing intrusion of the stirring bar 113 is provided in the opening of the stirring guide 114 facing the stirring bar 113, the accident that the stirring bar 113 enters the stirring guide 114 will not occur even if the guide height H502 is greater than the height of the stirring bar 113, and the water-flow generated by the stirring bar 113 can be caused to flow into the stirring guide 114 without leak.

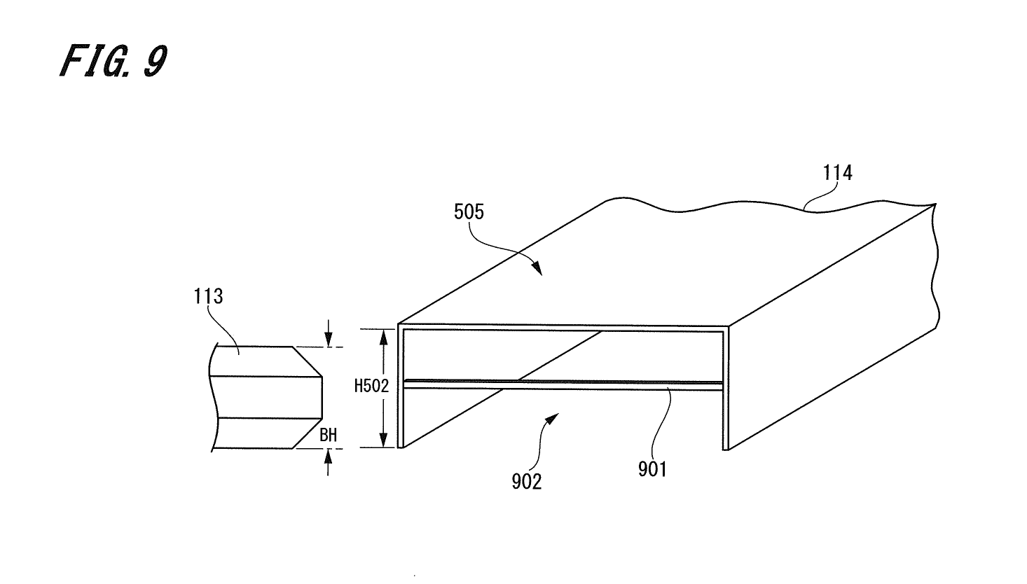

FIG. 9 is a partly enlarged perspective view of the stirring guide 114 for explaining an example of the intrusion preventing member. FIG. 9 also shows a part of the stirring bar 113 for purpose of reference.

An intrusion preventing bar 901 is arranged in an inlet 902 of the stirring guide 114 along a direction parallel to the upper plate 505. The height BH of the stirring bar 113 is smaller than the guide height H502; however, since the intrusion preventing bar 901 is arranged in a position lower than the height BH of the stirring bar 113, the intrusion preventing bar 901 prevents the accident that the stirring bar 113 enters the inlet 902 of the stirring guide 114.

(8) The stirring guide 114 may also be applied to a stirring device in which heating is not performed. The effect of the stirring guide 114 may also be expected when removing an embedding agent attached to the slide glass by stirring the liquid without performing heating.

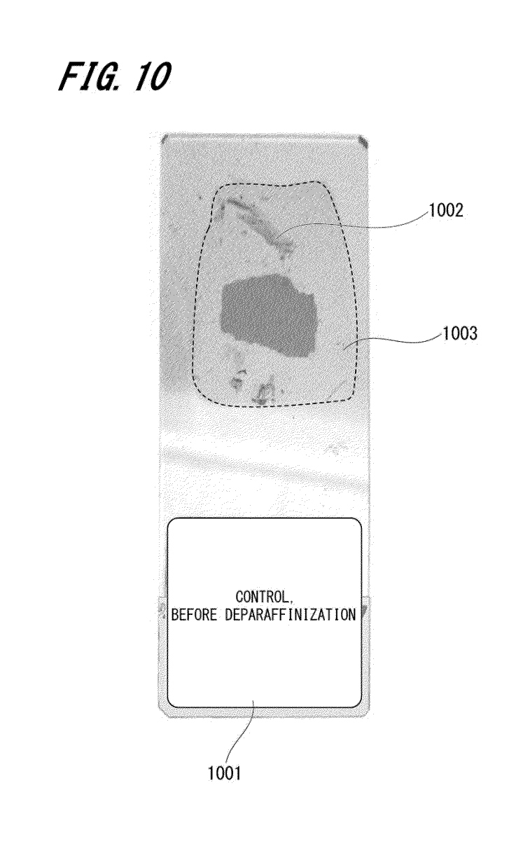

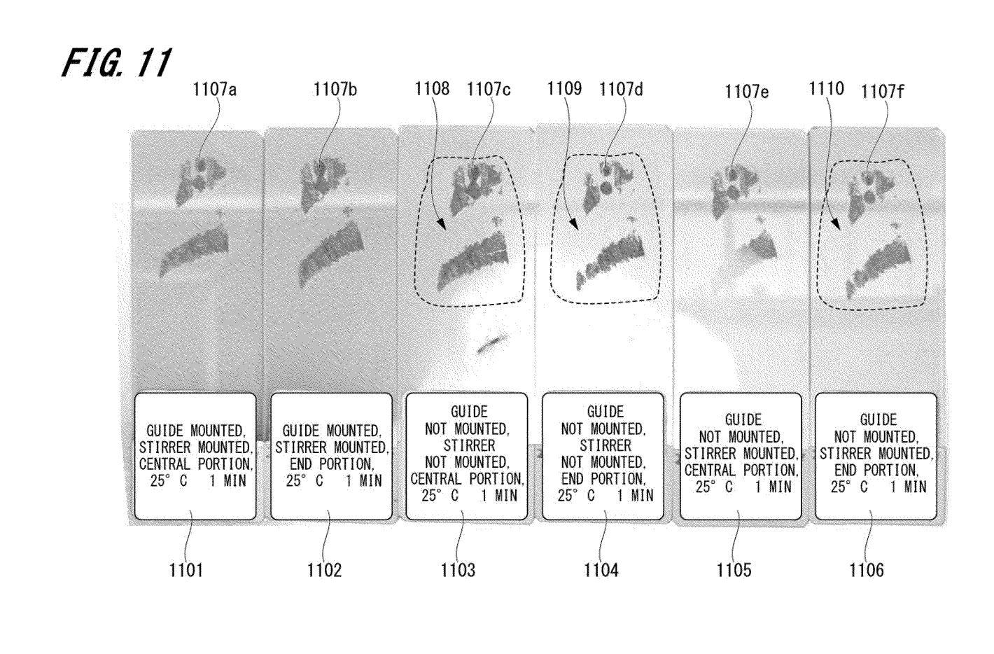

FIG. 10 is a photo of a slide glass before performing treatment in an experiment to remove an embedding agent attached to the slide glass, in a case where a room-temperature liquid is used in the thermostat 101 according to the embodiment of the present invention.

A thinly-sliced tissue 1002 is attached to a slide glass 1001. Further, there is paraffin 1003 (within a ranged enclosed by the dotted line) that covers the tissue 1002.

FIG. 11 is a photo showing results of the experiment to remove the embedding agent attached to the slide glass, in the case where a room-temperature liquid is used in the thermostat 101 according to the present embodiment.

Thinly-sliced tissues 1107a, 1107b, 1107c, 1107d, 1107e and 1107f are respectively attached to slide glasses 1101, 1102, 1103, 1104, 1105 and 1106. In order to remove the paraffin (which is an embedding agent) attached to the tissues 1107a, 1107b, 1107c, 1107d, 1107e and 1107f, SLIDE BRITE (a hydrocarbon organic solvent manufactured by Sasco Chemical Group, Inc.), as a embedding material remover, is filled in the tank 106 at 25° C., and stirring process is performing for one minute without switching on the band heater 111.

The slide glass 1101 and the slide glass 1102 were slide glasses used to perform an experiment in which the stirring bar 113 and the stirring guide 114 were mounted on the tank 106, and the stirring bar 113 was rotary-driven.

The experiment was performed in a state where the slide glass 1101 was disposed in the central portion of the tank 106, and the slide glass 1102 was disposed in the end portion of the tank 106.

In both the slide glass 1101 and the slide glass 1102, the embedding agent was well removed without leaving residue on the surface of the slide glass.

The slide glass 1103 and the slide glass 1104 were slide glasses used to perform an experiment in which neither the stirring bar 113 nor the stirring guide 114 were mounted on the tank 106.

The experiment was performed in a state where the slide glass 1103 was disposed in the central portion of the tank 106, and the slide glass 1104 was disposed in the end portion of the tank 106.

The slide glass 1103 had non-removed embedding agent, as residue 1108 (within a range enclosed by the dotted line), left on the surface thereof; and the slide glass 1104 also had non-removed embedding agent, as residue 1109 (within a range enclosed by the dotted line), left on the surface thereof.

The slide glass 1105 and the slide glass 1106 were slide glasses used to perform an experiment in which the stirring bar 113 and the stirring guide 114 were mounted on the tank 106, and the stirring bar 113 was not rotary-driven.

The experiment was performed in a state where the slide glass 1105 was disposed in the central portion of the tank 106, and the slide glass 1106 was disposed in the end portion of the tank 106.

Since the slide glass 1105 was disposed near the stirring bar 113, which was also disposed at the central portion of the bottom of the tank 106, due to the effect of the water-flow generated by the stirring bar 113, the embedding agent was well removed without leaving residue on the surface of the slide glass. However, since the slide glass 1106 was disposed at a position distant from the stirring bar 113, the effect of the water-flow generated by the stirring bar 113 was weak; and as a result, non-removed embedding agent left, as residue 1110 (within a range enclosed by the dotted line), on the surface of the slide glass 1106.

The amount of the residue of the embedding agent left on slide glasses 1101, 1102, 1103, 1104, 1105 and 1106 in the experiments is estimated into ten degrees as follows.

Slide glass 1001 (prior to treatment): 10

Slide glass 1101 (the stirring bar 113 was rotated, the stirring guide 114 was mounted, and the slide glass was disposed in the central portion): 0

Slide glass 1102 (the stirring bar 113 was rotated, the stirring guide 114 was not mounted, and the slide glass was disposed in the end portion): 0

Slide glass 1103 (the stirring bar 113 was not mounted, and the slide glass was disposed in the central portion): 4

Slide glass 1104 (the stirring bar 113 was not mounted, and the slide glass was disposed in the end portion): 4

Slide glass 1105 (the stirring bar 113 was rotated, the stirring guide 114 was not mounted, and the slide glass was disposed in the central portion): 0

Slide glass 1106 (the stirring bar 113 was rotated, the stirring guide 114 was not mounted, and the slide glass was disposed in the end portion): 2

Based on the results of the experiments, it is confirmed that the stirring guide 114 is also effective for a stirring device in which heating is not performed.

(9) Although the aforesaid embodiment is an example in which the stirring bar 113 is arranged in the central portion of the tank 106, the present invention also includes a configuration in which the stirring bar 113 is arranged in one end portion within the tank 106 in the longitudinal direction, and the water conduit formed by the stirring guide 114 is formed toward the other end portion within the tank 106 in the longitudinal direction. In such a case, the number of the stirring guide 114 is one.

(10) Although the aforesaid embodiment is an example in which the water conduit is formed by the stirring guide 114, the method for forming the water conduit does not have to be limited to such example, and the stirring guide 114 may also be integrated with the bottom of the tank 106.

(11) In the thermostat 101 of the aforesaid embodiment, if the number of the slide glasses 702 to be subjected to the treatment to contact the solution is large, one or two slide baskets 701 shown in FIG. 7 may be housed in the tank 106. In such a case, the volume of the tank 106 is extremely large with respect to the volume of the slide basket(s) 701. In other words, with respect to the amount of the solution necessary for the slide glasses 702 to contact the solution, the amount of the solution necessary for the tank 106 to reach a predetermined water level is too much, and therefore there is a large waste of solution. Such waste of solution causes an adverse effect: the time necessary for the temperature of the solution to reach a desired value becomes long. Further, if the solution is expensive, the cost of the treatment will become non-negligible.

Thus, if the number of the slide glasses 702 to be subjected to the treatment is small, in order to reduce the waste of the solution, the water level can be increased by putting spacer(s) in the tank 106.

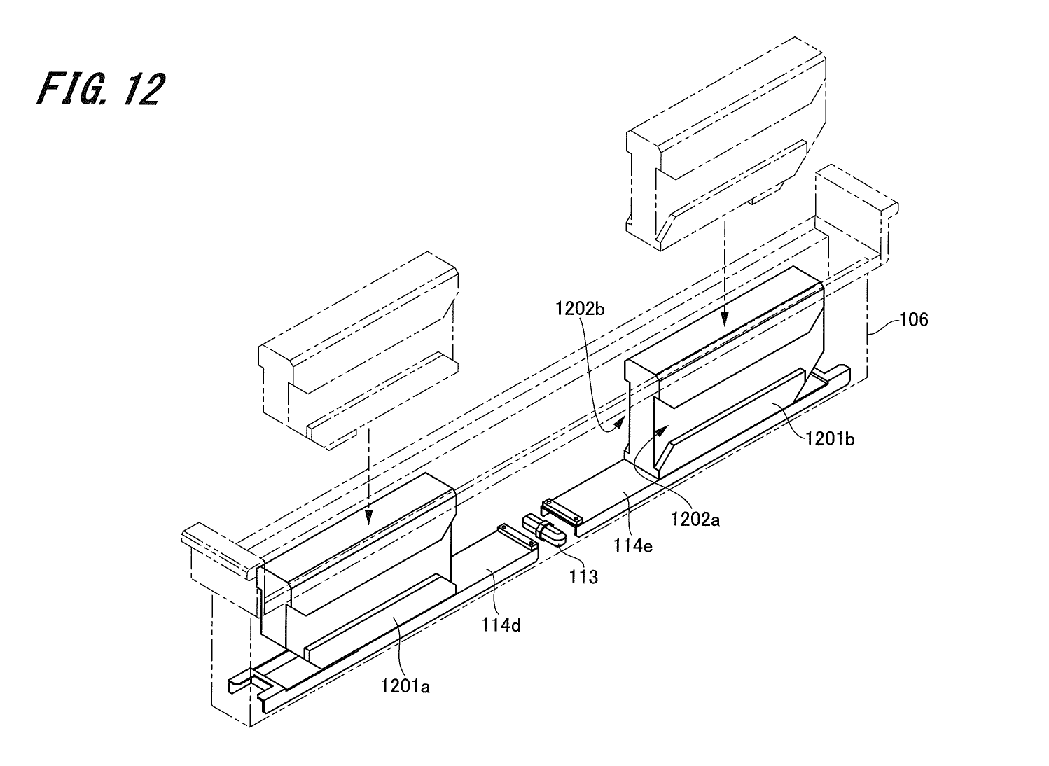

FIG. 12 is a perspective view showing the external appearance of the spacer, the stirring guide, and the tank 106. Note that, in order to clearly show the spacers, the tank 106 is indicated by dotted line.

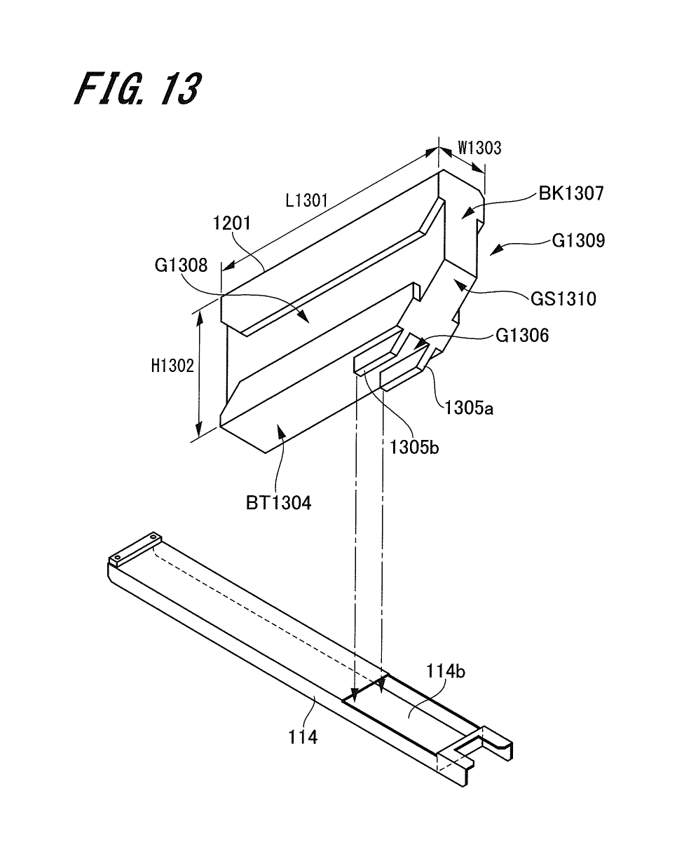

FIG. 13 is a perspective view showing the external appearance of the spacer and the stirring guide.

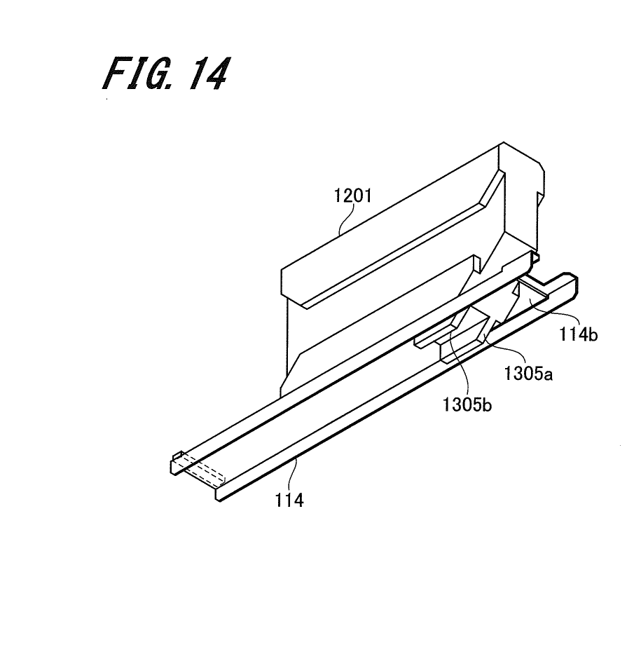

FIG. 14 is a perspective view showing the external appearance of the spacer and the stirring guide in a state where the spacer is mounted on the stirring guide.

As can be known from FIG. 12, two spacers 1201a and 1201b having the same shape and size are provided in one tank 106, and are sunk into both ends. Hereinafter, the spacers 1201a and 1201b are collectively referred to as a “spacer 1201”.

The spacer 1201 is formed by cutting or injection molding a synthetic resin having chemical stability and heat-resisting property, such as polyethylene, polystyrene, polypropylene, ABS resin and the like. Incidentally, since the spacer 1201 is to be sunk in the tank 106, it is preferred that the specific gravity thereof is large with respect to the liquid such as water. If the specific gravity of the synthetic resin used to form the spacer 1201 is smaller than water, it is necessary to reduce buoyancy by embedding a weight (such as lead, iron or the like) into the central portion of the spacer 1201, forming an engaging portion for fitting the spacer 1201 into the stirring guide 114, or the like. In the case of the spacer 1201 of the present embodiment, two projections 1305a and 1305b (which are to be described later) are fitted into the opening 114b of the stirring guide 114 to thereby prevent the spacer 1201 from floating up.

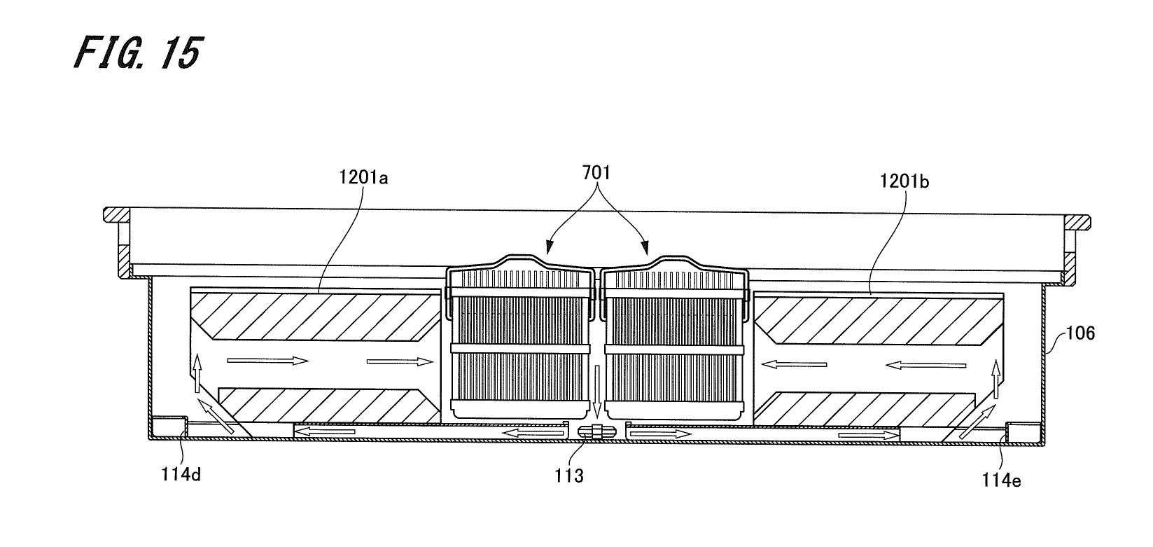

As can be known from FIG. 15 (which is to be described later), the length L1301 of the spacer 1201 in the longitudinal direction is such that a space for housing one or two slide baskets 701 in the central portion of the tank 106 can be reliably obtained.

When being coupled with the height H502 of the stirring guide 114, the height H1302 of the spacer 1201 is substantially equal to the height of the inner wall of the tank 106. Obviously the condition is: the tank cover 301 is normally mounted on the tank 106, and the outer lid 107 is normally closed. In other words, in the state where the spacer 1201 has sunk into the tank 106, the height of the spacer 1201 is greater than the height of the surface of the liquid filled in the tank 106.

The width W1303 of the spacer 1201 is substantially equal to the width of the inner wall of the tank 106.

The projections 1305a and 1305b are formed on a bottom face BT1304 of the spacer 1201, the bottom face BT1304 contacting the stirring guide 114. As can be known from FIG. 14, the projections 1305a and 1305b are fitted into the opening 114b of the stirring guide 114, and play a role in positioning the spacer 1201 with respect to the stirring guide 114. Further, the two projections 1305a and 1305b form a groove G1306, and the liquid passing through the stirring guide 114 is expelled along the groove G1306. Further, in order to guide the liquid expelled from the opening 114b of the stirring guide 114, the spacer 1201, together with the projections 1305a and 1305b, is diagonally cut off to the bottom face BT1304 and a back face BK1307.

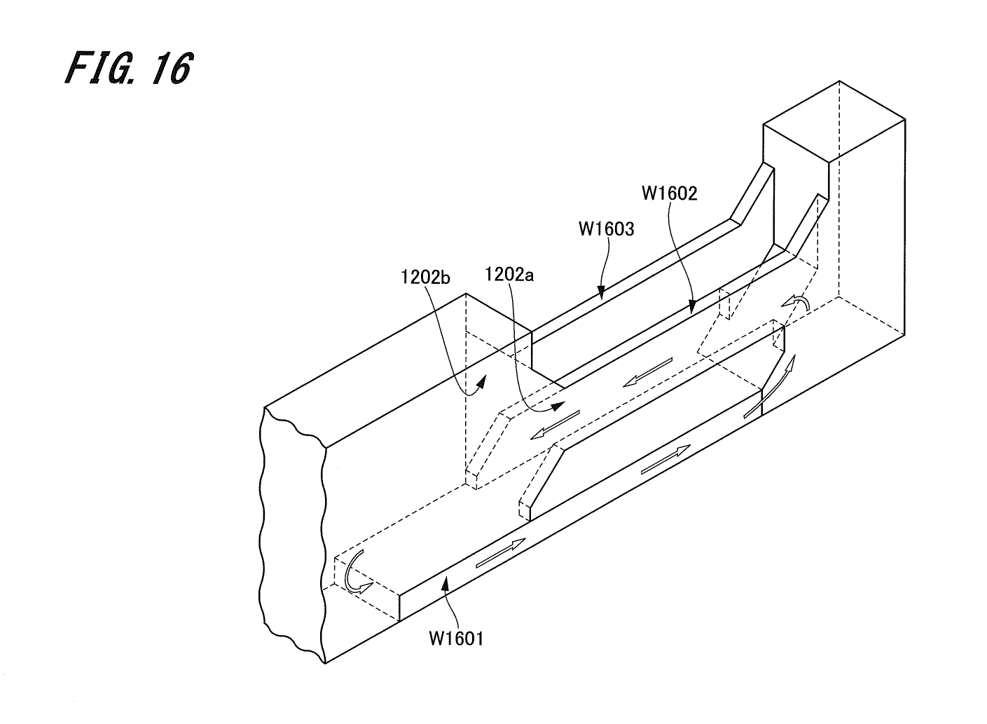

Two grooves G1308 and G1309 are formed in both side faces of the spacer 1201. The grooves G1308 and G1309 are coupled with the inner wall of the tank 106 to thereby form a water conduit shown in FIG. 16 (which is to be described later). Further, in order for the liquid to be easily guided, the inlet portion and outlet portion of the water conduit formed by the grooves G1308 and G1309 are each cut off into substantially a fan shape.

Incidentally, the inlet portion and outlet portion of the water conduit does not have to be cut off into substantially a fan shape. The inlet portion and outlet portion of the water conduit may also be cut off into a rectangular shape. What is essential is that the width of the inlet portion and outlet portion of the water conduit needs to be larger than the width of the water conduit.

FIG. 15 is a transverse cross section of the tank 106 in a state where the spacer 1201 has been housed.

FIG. 16 is a view showing the concept of the water conduit formed by the spacer 1201, the tank 106 and the stirring guide 114.

When the stirring bar 113 is rotary-driven, the liquid flows into a water conduit W1601 formed by the stirring guide 114 and the bottom of the tank 106. After passing through the water conduit W1601, the liquid is expelled from the opening 114b of the stirring guide 114. An expelling guide face GS1310 of the spacer 1201 faces the opening 114b of the stirring guide 114. The liquid is expelled along the expelling guide face GS1310.

The liquid expelled from the opening 114b of the stirring guide 114 enters a water conduit W1602 and a water conduit W1603 respectively formed by the groove G1308 and the groove G1309 formed on both sides of the spacer 1201. After passing through the water conduit W1602 and water conduit W1603, the liquid is expelled from an opening 1202a and an opening 1202b provided on both front sides of the spacer 1201. The liquid expelled from the opening 1202a and the opening 1202b contacts the slide glasses 702 housed in the slide basket 701, and then flows into the water conduit W1601 formed by the stirring guide 114 and the bottom of the tank 106 again due to the rotary-driven stirring bar 113.

Incidentally, even if a slight gap is formed between the side face of the spacer 1201 and the inner wall of the tank 106, since the only requirement is that the water conduits W1602 and W1603 are substantially formed by the side face of the spacer 1201 and the inner wall of the tank 106, the side face of the spacer 1201 does not have to adhere tightly to the inner wall of the tank 106.

Owing to the provision of the spacer 1201, the thermostat 101 achieves the following advantages, compared with the state where the spacer 1201 is not provided.

<1> The amount of the liquid necessary for the slide glasses 702 to contact the liquid can be reduced. Since only small amount of the liquid is needed, time necessary for raising the temperature with the band heater 111 can be reduced, and power consumption can be reduced. Further, in the case where the liquid is expensive, the cost can be reduced.

<2> By suitably setting the cross-sectional area of the water conduit W1602 and water conduit W1603 respectively formed by the groove G1308 and groove G1309 of the spacer 1201, the speed of the liquid expelled from the water conduit W1602 and water conduit W1603 can be increased. In other words, compared with the state where the spacer 1201 is not provided, the momentum of the liquid that contacts the slide glasses 702 is strong, and therefore reaction speed can be increased.

In the thermostat 101 disclosed as the embodiment of the present invention, the stirring guide 114, which is adapted to guide the water-flow generated by the stirring bar 113 to the ends of the tank 106 in the longitudinal direction, is arranged on the bottom of the tank 106. Thus, the water-flow generated by the stirring bar 113 is efficiently guided to the ends of the tank 106 in the longitudinal direction while keeping its momentum, and therefore the circulating water-flow for homogenizing the temperature of the water within the tank 106 can be effectively generated.

The embodiment of the present invention is described above; it is to be understood that the present invention is not limited to the embodiment described above, and various modifications and applications can be made without departing from the spirit and scope of the claims of the present invention.

### EXPLANATION OF REFERENCE NUMERALS

101 thermostat
102 first tank housing
103 second tank housing
104 third tank housing
105 casing
106 tank
107 outer lid
108 first inlet
109 second inlet
110 third inlet
111 band heater
112 water level sensor
113 stirring bar
114 stirring guide
201 steam pipe
202 beaker
203 outlet
204 hinge
301 tank cover
505 upper plate
601 magnet
602 motor
603 frame
702 slide glass
811 water
901 intrusion preventing bar
902 inlet
1001 slide glass
1002 tissue
1003 paraffin
1101, 1102, 1103, 1104, 1105, 1106 slide glass
1108, 1109, 1110 residue
1201 spacer

1. A thermostat comprising:
a tank formed in a shape that having a longitudinal direction and a transversal direction and adapted to contain a liquid;
a temperature changing unit arranged on the outer side of the tank and adapted to change the temperature of the liquid through the tank;
a rotating body arranged within the bottom of the tank;
a drive unit adapted to rotary-drive the rotating body; and
a bottom-side water conduit arranged within the bottom of the tank in a position adjacent to the rotating body and adapted to guide a water-flow generated in the liquid by rotating the rotating body to an end of the tank in the longitudinal direction and then open the water-flow upward.

2. The thermostat according to claim 1, wherein the bottom-side water conduit comprises:
a water conduit cover adapted to guide the water-flow to the end of the tank in the longitudinal direction; and
an opening adapted to open the water-flow guided by the water conduit cover upward,
wherein the water conduit cover includes a rectangular upper plate and two side plates respectively formed continuously from two long sides of the upper plate, and is adapted to guide, in combination with the bottom of the tank, the water-flow to the end of the tank in the longitudinal direction.

3. The thermostat according to claim 2,
wherein the rotating body is arranged at the center of the bottom within the tank, and
wherein the bottom-side water conduits are arranged on both sides of the rotating body along the longitudinal direction of the tank.

4. The thermostat according to claim 3,
wherein the drive unit is configured by a motor arranged outside the bottom of the tank, and a driving magnet rotary-driven by the motor, and
wherein the rotating body is a stirring bar which has a magnet built therein and which is rotary-driven due to the rotation of the driving magnet.

5. The thermostat according to claim 4, wherein the bottom-side water conduits each comprise:
a water conduit cover adapted to guide the water-flow to the end of the tank in the longitudinal direction; and
an opening adapted to open the water-flow guided by the water conduit cover upward,
wherein the height of the water conduit cover is equal to or less than the height of the rotating body.

6. The thermostat according to claim 4, wherein the bottom-side water conduits each comprise:
a water conduit cover adapted to guide the water-flow to the end of the tank in the longitudinal direction;
an opening adapted to open the water-flow guided by the water conduit cover upward; and
a guide arranged in the opening and adapted to prevent the intrusion of the stirring bar,
wherein the height of the water conduit cover is equal to or larger than the height of the rotating body.

7. The thermostat according to claim 1, further comprising:
a spacer arranged within the tank and adapted to increase the water level of the liquid in the tank.

8. The thermostat according to claim 7, wherein the spacer has a groove, which constitute a water conduit, formed in a surface thereof facing the side face of the tank.

9. The thermostat according to claim 2, further comprising:
a spacer mounted on the water conduit cover within the tank and adapted to increase the water level of the liquid in the tank.

10. The thermostat according to claim 9, wherein the spacer has a groove, which constitute a water conduit, formed in a surface thereof facing the side face of the tank.
